(19) United States
(12) Patent Application Publication
(10) Pub. No.: US 2016/0106111 A1
(43) Pub. Date: Apr. 21, 2016

(54) COMBINATION POTATO CHIP AND PRETZEL AND METHOD FOR MAKING THE SAME

(71) Applicant: Reading Bakery Systems, Inc., Robesonia, PA (US)

(72) Inventors: Joseph S. ZALESKI, JR., Mohrsville, PA (US); Kenneth J. ZVONCHECK, Sinking Spring, PA (US)

(21) Appl. No.: 14/918,001

(22) Filed: Oct. 20, 2015

Related U.S. Application Data
(60) Provisional application No. 62/066,029, filed on Oct. 20, 2014.

(51) Int. Cl. A21D 13/00; A23L 1/217; A23L 1/00

(52) U.S. Cl. CPC A21D 13/0051; A23L 1/0067; A23L 1/217; A23V 2002/00

(57) ABSTRACT

A composite potato chip and pretzel product includes a first layer made from a first dough and a second layer made from a second dough adjacent the first layer. The first dough is a potato dough and the second dough is a wheat dough. Also provided is a method for making a composite potato chip and pretzel product. Potato dough and wheat dough are prepared and passed through first and second sheet rollers, respectively, to produce a composite dough sheet having a potato dough layer adjacent a wheat dough layer. The composite dough sheet is then cut into a plurality of individual composite dough pieces, a layer of a cooker solution is applied on the wheat dough layer to form coated composite dough pieces. The coated composite dough pieces are then baked and subsequently dried to form a plurality of the composite potato chip and pretzel product.

### CROSS-REFERENCE TO RELATED APPLICATIONS

This application claims the benefit of U.S. Provisional Patent Application No. 62/066,029, filed on Oct. 20, 2014, the entire contents of which are incorporated by reference herein.

### BACKGROUND OF THE INVENTION

The present invention is generally directed to a food product, and, more particularly, to a baked food product incorporating a combination of a baked potato chip and a pretzel and a method for making the baked food product.

Potato chips and pretzels have been made for years. Many consumers enjoy eating both potato chips and pretzels. However, to date, potato chips and pretzels have generally been produced as two separate food products, requiring two separate purchases. Therefore, it would be desirable to provide a single baked food product incorporating a combination of both a potato chip and a pretzel.

### BRIEF SUMMARY OF THE INVENTION

In one embodiment, the present invention is directed to a composite potato chip and pretzel product comprising a first layer made from a first dough comprising a potato dough and a second layer adjacent the first layer. The second layer is made from a second dough comprising a wheat dough.

In another embodiment, the present invention is directed to a process for making a composite potato chip and pretzel product. The process comprises preparing a first dough made up of a potato dough and preparing a second dough made up of a wheat dough; passing the first dough through a first sheet roller to produce a potato dough sheet and passing the second dough through a second sheet roller to produce a wheat dough sheet, the first and second sheet rollers being oriented such that the potato dough sheet and the wheat dough sheet are outputted from the first and second sheet rollers as a composite dough sheet having a first potato dough layer adjacent a second wheat dough layer; cutting the composite dough sheet into a plurality of individual composite dough pieces; applying a layer of a cooker solution on an exposed surface of the wheat dough layer of each composite dough piece to form a plurality of coated composite dough pieces; baking the plurality of coated composite dough pieces to form a plurality of baked composite dough pieces; and drying the plurality of baked composite dough pieces to form a plurality of the composite potato chip and pretzel product.

### BRIEF DESCRIPTION OF THE SEVERAL VIEWS OF THE DRAWINGS

The following detailed description of preferred embodiments of the invention will be better understood when read in conjunction with the appended drawings. It should be understood, however, that the disclosure is not limited to the precise arrangements and instrumentalities shown. In the drawings:

FIG. 1 is a top perspective view of a combination potato chip and pretzel, according to a preferred embodiment of the invention;

FIG. 2 is a bottom perspective view of the combination potato chip and pretzel of FIG. 1; and

FIG. 3 is a cross-sectional elevational view of the combination potato chip and pretzel of FIG. 1, taken along the sectional line 3-3 of FIG. 1.

### DETAILED DESCRIPTION OF THE INVENTION

Certain terminology is used in the following description for convenience only and is not limiting. The words “lower,” “bottom,” “upper” and “top” designate directions in the drawings to which reference is made. The words “inwardly,” “outwardly,” “upwardly” and “downwardly” refer to directions toward and away from, respectively, the geometric center of the food product, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

It should also be understood that the terms “about,” “approximately,” “generally,” “substantially” and like terms, used herein when referring to a dimension or characteristic of a component of the invention, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

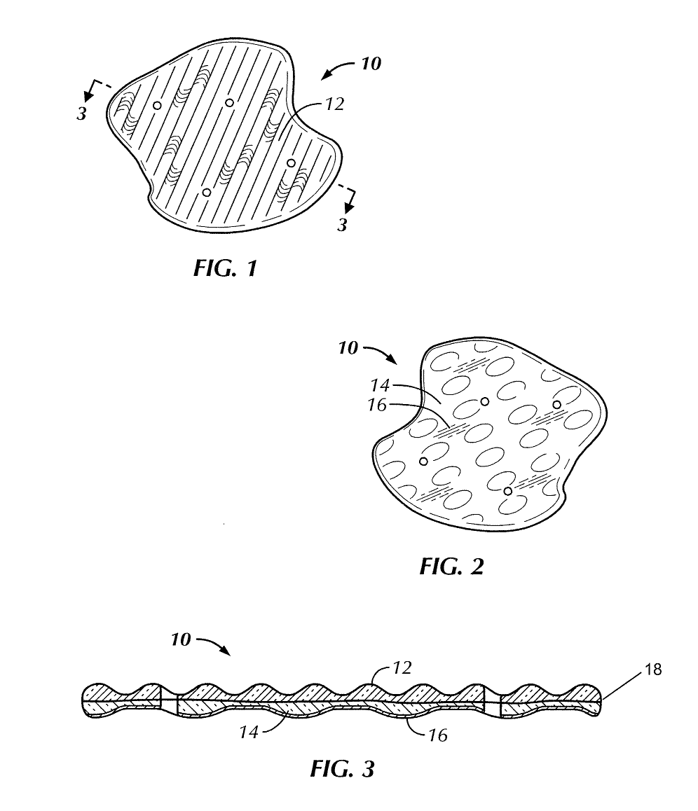

Referring to the drawings in detail, wherein like numerals indicate like elements throughout, there is shown in FIGS. 1-3, a food product, generally designated 10, in accordance with the present invention. Preferably the food product 10 is a baked food product. In one embodiment, the food product 10 is a composite or combination potato chip and pretzel and, more preferably, a baked combination potato chip and pretzel. The food product 10 is comprised of a first layer or sheet 12 and a second layer or sheet 14 adjacent, and more particularly laminated to, the first sheet 12. The first sheet 12, best shown in FIGS. 1 and 3, is preferably made of a first dough, namely a potato dough. The opposing second sheet 14, best shown in FIGS. 2-3, is preferably made of second dough, namely a wheat dough. Prior to cooking, an exposed surface of the wheat dough sheet 14 is preferably coated with a layer of a cooker solution 16 (see FIG. 2). Preferably, the cooker solution 16 is a caustic, alkaline solution, and more preferably a caustic soda solution, which allows a pretzel-like texture and flavor to be created when the food product 10 is baked.

In one embodiment, the potato dough sheet 12 is generally comprised of a combination of potato flakes, corn starch, monocalcium phosphate, sodium bicarbonate, sugar and salt. The potato flakes comprise between approximately 52.8% and approximately 79.2% of the potato dough sheet 12. Preferably, the potato flakes comprise between approximately 59.4% and approximately 72.6% of the potato dough sheet 12, and more preferably, for example and without limitation, approximately 66% of the potato dough sheet 12. The corn starch comprises between approximately 19.52% and approximately 29.28% of the potato dough sheet 12. Preferably, the corn starch comprises between approximately 21.96% and approximately 26.84% of the potato dough sheet 12, and more preferably, for example and without limitation, approximately 24.4% of the potato dough sheet 12. The sugar comprises between approximately 5.76% and approximately 8.64% of the potato dough sheet 12. Preferably, the sugar comprises between approximately 6.48% and approximately 7.92% of the potato dough sheet 12, and more preferably, for example and without limitation, approximately 7.2% of the potato dough sheet 12. The salt comprises between approximately 1.28% and approximately 1.92% of the potato dough sheet 12. Preferably, the salt comprises between approximately 1.44% and approximately 1.76% of the potato dough sheet 12, and more preferably, for example and without limitation, approximately 1.6% of the potato dough sheet 12.

The monocalcium phosphate comprises between approximately 0.32% and approximately 0.48% of the potato dough sheet 12. Preferably, the monocalcium phosphate comprises between approximately 0.36% and approximately 0.44% of the potato dough sheet 12, and more preferably, for example and without limitation, approximately 0.4% of the potato dough sheet 12. The sodium bicarbonate comprises between approximately 0.32% and approximately 0.48% of the potato dough sheet 12. Preferably, the sodium bicarbonate comprises between approximately 0.36% and approximately 0.44% of the potato dough sheet 12, and more preferably, for example and without limitation, approximately 0.4% of the potato dough sheet 12. Unless stated otherwise, it will be understood that all of the percentages disclosed herein are weight percentages based on a dry and uncooked form of each dough, i.e., weight percentages prior to mixing and/or baking of the dough. As also should be understood by those of ordinary skill in the art, additional or replacement ingredients may be included or substituted to prepare the potato dough, such as, for example, without limitation, to prepare different potato dough flavors. It will be understood that the potato dough sheet 12 may comprise any one or more ingredients known in the art for making potato chips.

In one embodiment, the wheat dough sheet 14 is generally comprised of wheat flour, soy oil and corn syrup. Preferably, the wheat flour comprises between approximately 93.6% and approximately 98.4% of the wheat dough sheet 14, and more preferably, for example and without limitation, approximately 96% of the wheat dough sheet 14. Preferably, the soy oil comprises between approximately 1.95% and approximately 2.05% of the wheat dough sheet 14, and more preferably, for example and without limitation, approximately 2% of the wheat dough sheet 14. The corn syrup preferably comprises between approximately 1.95% and approximately 2.05% of the wheat dough sheet 14, and more preferably, for example and without limitation, approximately 2% of the wheat dough sheet 14. As should be understood by those of ordinary skill in the art, additional or replacement ingredients may be included or substituted to prepare the wheat dough, such as, for example, without limitation, to prepare different wheat dough flavors. It will be understood that the wheat dough sheet 14 may comprise any one or more ingredients known in the art for making pretzels.

In one embodiment, the cooker solution coating layer 16 is comprised of sodium hydroxide and water. Preferably, the water comprises approximately 93.6% and approximately 98.4% by volume of the cooker solution 16, and more preferably, for example and without limitation, approximately 96% by volume of the cooker solution 16. Preferably, the sodium hydroxide comprises between approximately 3.9% and approximately 4.1% by volume, and more preferably, for example and without limitation, approximately 4% by volume of the cooker solution 16. As should be understood by those of ordinary skill in the art, the cooker solution layer 16 provides the wheat dough sheet 14 with the brown pretzel-like color and the pretzel-like texture when coated and cooked (e.g., baked) thereon. It will be understood that the cooker solution 16 may comprise any one or more ingredients known in the art for making a coating or dipping solution for pretzels.

To begin, a method of making the food product 10, in accordance with an embodiment of the present invention, comprises separately preparing the potato dough which makes up the potato dough sheet 12 and the wheat dough which makes up the wheat dough sheet 14 from their respective ingredients, as described above. The potato dough and wheat dough may be prepared in any manner well known by those of ordinary skill in the art, such as by mixing the respective and separate ingredients of each dough. The potato dough and the wheat dough are thereafter inserted into and passed through first and second standard sheet rollers, respectively, and more particularly cracker sheeters or sheeting rolls as will be understood by those of ordinary skill in the art, to produce a first, relatively thin potato dough sheet 12 and a second wheat dough sheet 14, respectively. The cracker sheeters are oriented relative to one another in a manner to output the first potato and second wheat dough sheets 12, 14 in a laminated, layered or stacked configuration (i.e., one sheet stacked on top of the other) as a composite sheet 18. For example, as shown in FIG. 3, the potato and wheat dough sheets 12, 14 are outputted from the cracker sheeters such that the composite sheet 18 includes the potato dough sheet 12 oriented atop the wheat dough sheet 14. However, as will be understood by those of ordinary skill in the art, the sheets 12, 14 may alternatively be oriented such that the wheat dough sheet 14 lies atop the potato dough sheet 12.

Also, as will be understood by those of ordinary skill in the art, the cracker sheeters may output the sheets 12, 14, such that the sheets 12, 14 have different respective textured surfaces. For example, without limitation, the output potato dough sheet 12 may have a first, rippled exposed surface, such as a rippled potato chip, and a second, opposing flat surface configured to contact or in contact with the wheat dough sheet 14. Likewise, the output the wheat dough sheet 14 may have a first, bumpy exposed surface and a second, opposing flat surface configured to contact or in contact with the potato dough sheet 12. Alternatively, at least one or both of the potato and wheat dough sheets 12, 14 may be outputted having generally flat surfaces on both sides.

Thereafter, the composite sheet 18 made up of the stacked potato and wheat dough sheets 12, 14 is cut into a plurality of individual composite dough pieces 10. In one embodiment, the composite sheet 18 is advanced through a standard rotary cutter, in a manner well understood by those of ordinary skill in the art, which cuts the laminated potato and wheat dough sheets 12, 14 into the plurality of uncooked, composite potato dough and wheat dough pieces 10. Also, as will be understood by those of ordinary skill in the art, the rotary cutter may cut the composite sheet 18 of the stacked potato and wheat dough sheets 12, 14 into a plurality of different shapes. In one embodiment, the composite dough pieces 10 may also include a plurality of small apertures therethrough, formed in a standard manner well understood by those of ordinary skill in the art.

Next, a layer 16 of the cooker solution is applied to an exposed surface of the wheat dough sheet of each dough piece 10 to form a plurality of coated composite dough pieces 10. Preferably, the plurality of individual uncooked, composite dough pieces 10 are dipped into a standard pretzel cooker (not shown), in a manner well understood by those of ordinary skill in the art, containing the cooker solution 16 such that the exposed surface of the wheat dough sheet 14 is coated with a layer 16 of the cooker solution. Alternatively, the coating layer 16 of the cooker solution may be applied onto the exposed surface of the wheat dough sheet 14 in any of numerous different methods known in the art, such as, for example, via a brushing mechanism.

The plurality of coated composite dough pieces 10 are then baked to form a plurality of baked composite dough pieces 10. In one embodiment, the plurality of coated composite dough pieces 10 are placed in a dual zone oven (not shown) for baking and, subsequently, in a dryer (not shown) for drying the baked composite dough pieces 10. It will be understood that the baking and drying may both occur within the oven in different heating zones. In one embodiment, the individual pieces 10 are placed on a conveyer (not shown) configured to pass through the oven and the dryer at the appropriate intervals, to allow the pieces 10 to remain in each zone for the appropriate period of time. It will be understood by those of ordinary skill in the art that any known method for dual zone cooking may be utilized.

In a first zone of the oven, the individual coated composite dough pieces 10 (i.e., the composite potato dough and wheat dough sheets 12, 14 with a caustic soda solution coated on the wheat dough sheet 14) are baked at a first temperature, preferably approximately 500° F., for a first predetermined duration, preferably approximately one and a half minutes. In the first oven zone, there is substantially 90% circulation (of the maximum circulation blower speed) and substantially 10% exhaust (of the maximum exhaust blower speed). As will be understood by those of ordinary skill in the art, the oven circulation determines the amount of airflow blowing over the product within the oven chamber, and oven exhaust determines the amount of moisture baking off of the dough that is allowed to exit out of the oven chamber.

In a second zone of the oven, the individual coated composite dough pieces 10 are baked at a second temperature which is less than the first temperature, preferably approximately 430° F., for a second predetermined duration, preferably approximately another one and a half minutes. In the second oven zone, substantially 90% circulation remains, but the exhaust is preferably increased to substantially 90%. Thereafter, the plurality of baked composite dough pieces 10 are dried to form a plurality of the composite potato chip and pretzel product 10. In one embodiment, the plurality of baked composite dough pieces 10 are advanced into a dryer zone of the oven or a separate dryer at a third temperature for approximately sixteen minutes. The third temperature is preferably less than the first and second temperatures, and more preferably approximately 230° F. The circulation and exhaust during drying are substantially 100%. As such, the individual dough pieces 10 are fully baked and transformed into a plurality of the combination potato chip and pretzel pieces 10. Afterwards, the combination potato chip and pretzel pieces 10 are ready for packaging.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A composite potato chip and pretzel product comprising:
a first layer made from a first dough comprising a potato dough; and
a second layer adjacent the first layer, the second layer being made from a second dough comprising a wheat dough.

2. The composite potato chip and pretzel product according to claim 1, wherein the composite potato chip and pretzel product is a baked product.

3. The composite potato chip and pretzel product according to claim 1, wherein the potato dough comprises potato flakes, corn starch, monocalcium phosphate, sodium bicarbonate, sugar and salt.

4. The composite potato chip and pretzel product according to claim 3, wherein, in a dry and uncooked form, the potato dough comprises:
between approximately 59.4% and approximately 72.6% by weight of the potato flakes;
between approximately 519.52% and approximately 29.28% by weight of the corn starch;
between approximately 5.76% and approximately 8.64% by weight of the sugar;
between approximately 1.28% and approximately 1.92% by weight of the salt;
between approximately 0.32% and approximately 0.48% by weight of the monocalcium phosphate; and
between approximately 0.32% and approximately 0.48% by weight of the sodium bicarbonate.

5. The composite potato chip and pretzel product according to claim 1, wherein the wheat dough comprises wheat flour, soy oil and corn syrup.

6. The composite potato chip and pretzel product according to claim 5, wherein, in a dry and uncooked form, the wheat dough comprises:
between approximately 93.6% and approximately 98.4% by weight of the wheat flour;
between approximately 1.95% and approximately 2.05% by weight of the soy oil; and
between approximately 1.95% and approximately 2.05% by weight of the corn syrup.

7. A process for making a composite potato chip and pretzel product comprising:
preparing a first dough made up of a potato dough and preparing a second dough made up of a wheat dough;
passing the first dough through a first sheet roller to produce a potato dough sheet and passing the second dough through a second sheet roller to produce a wheat dough sheet, the first and second sheet rollers being oriented such that the potato dough sheet and the wheat dough sheet are outputted from the first and second sheet rollers as a composite dough sheet having a first potato dough layer adjacent a second wheat dough layer;
cutting the composite dough sheet into a plurality of individual composite dough pieces;
applying a layer of a cooker solution on an exposed surface of the wheat dough layer of each composite dough piece to form a plurality of coated composite dough pieces;
baking the plurality of coated composite dough pieces to form a plurality of baked composite dough pieces; and
drying the plurality of baked composite dough pieces to form a plurality of the composite potato chip and pretzel product.

8. The process according to claim 7, wherein the potato dough comprises potato flakes, corn starch, monocalcium phosphate, sodium bicarbonate, sugar and salt.

9. The process according to claim 8, wherein, in a dry and uncooked form, the potato dough comprises:
between approximately 59.4% and approximately 72.6% by weight of the potato flakes;
between approximately 519.52% and approximately 29.28% by weight of the corn starch;
between approximately 5.76% and approximately 8.64% by weight of the sugar;
between approximately 1.28% and approximately 1.92% by weight of the salt;
between approximately 0.32% and approximately 0.48% by weight of the monocalcium phosphate; and
between approximately 0.32% and approximately 0.48% by weight of the sodium bicarbonate.

10. The process according to claim 7, wherein the wheat dough comprises wheat flour, soy oil and corn syrup.

11. The process according to claim 10, wherein, in a dry and uncooked form, the wheat dough comprises:
between approximately 93.6% and approximately 98.4% by weight of the wheat flour;
between approximately 1.95% and approximately 2.05% by weight of the soy oil; and
between approximately 1.95% and approximately 2.05% by weight of the corn syrup.

12. The process according to claim 7, wherein the cooker solution is a soda solution.

13. The process according to claim 12, wherein the soda solution comprises sodium hydroxide and water.

14. The process according to claim 13, wherein the soda solution comprises between approximately 93.6% and approximately 98.4% by volume of the water and between approximately 3.9% and approximately 4.1% by volume of the sodium hydroxide.

15. The process according to claim 7, wherein the plurality of coated composite dough pieces are baked a first temperature and subsequently a second temperature lower than the first temperature.

16. The process according to claim 15, wherein the first temperature is approximately 500° F. and the second temperature is approximately 430° F.
